(19) United States
(12) Patent Application Publication
(10) Pub. No.: US 2018/0018897 A1
(43) Pub. Date: Jan. 18, 2018

(54) Writing Guide

(71) Applicant: Tiffany Harris, Cranberry Township, PA (US)

(72) Inventor: Tiffany Harris, Cranberry Township, PA (US)

(21) Appl. No.: 15/212,995

(22) Filed: Jul. 18, 2016

(51) Int. Cl. G09B 11/04

(52) U.S. Cl. CPC G09B 11/04

(57) ABSTRACT

A writing guide for enhancing penmanship includes a mask that is substantially rectangularly shaped. The mask has a top, a bottom and opposing sides. An aperture is positioned through the mask. The aperture is substantially rectangularly shaped. The aperture has a top edge, a bottom edge and opposing side edges. The mask is configured to position over a sheet of lined paper. The top edge and the bottom edge of the aperture are alignable with respective lines of the sheet of lined paper. A first writing space of the sheet of lined paper is accessible to a writing instrument positioned through the aperture. The mask covers at least one writing space above and one writing space below the first writing space, such that a user is restricted to writing in the first writing space until the mask is repositioned relative to the sheet of lined paper.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to writing guides and more particularly pertains to a new writing guide for enhancing penmanship.

### BRIEF SUMMARY OF THE INVENTION

An embodiment of the disclosure meets the needs presented above by generally comprising a mask that is substantially rectangularly shaped. The mask has a top, a bottom and opposing sides. An aperture is positioned through the mask. The aperture is substantially rectangularly shaped. The aperture has a top edge, a bottom edge and opposing side edges. The mask is configured to position over a sheet of lined paper. The top edge and the bottom edge of the aperture are alignable with respective lines of the sheet of lined paper. A first writing space of the sheet of lined paper is accessible to a writing instrument positioned through the aperture. The mask covers at least one writing space above and one writing space below the first writing space, such that a user is restricted to writing in the first writing space until the mask is repositioned relative to the sheet of lined paper.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a writing guide according to an embodiment of the disclosure.

FIG. 2 is a bottom view of an embodiment of the disclosure.

FIG. 3 is a front view of an embodiment of the disclosure.

FIG. 4 is a cross-sectional view of an embodiment of the disclosure.

FIG. 5 is an in-use view of an embodiment of the disclosure.

### DETAILED DESCRIPTION OF THE INVENTION

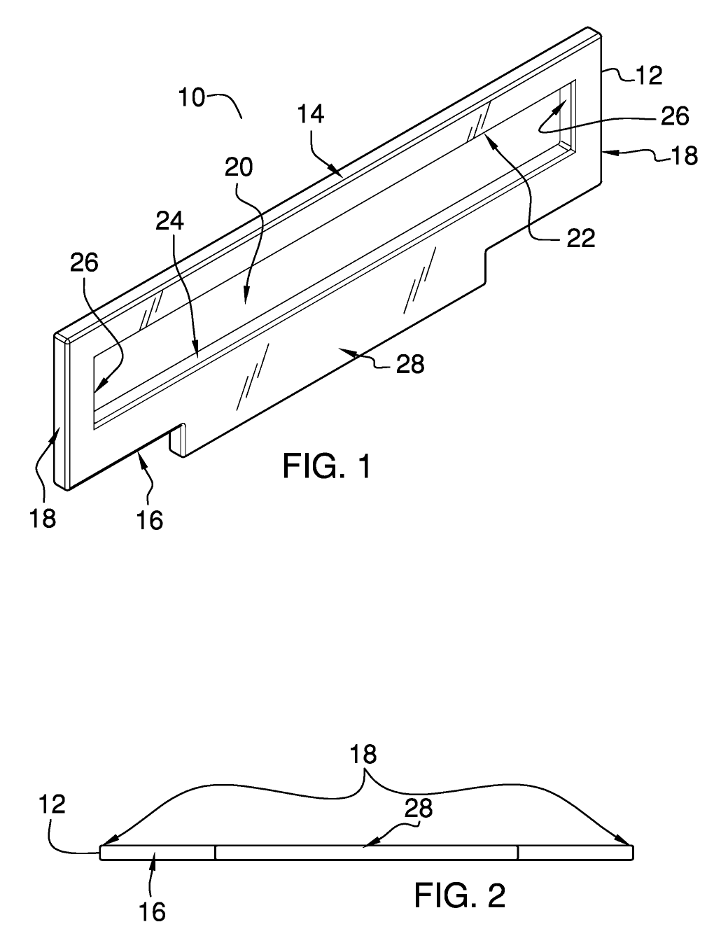

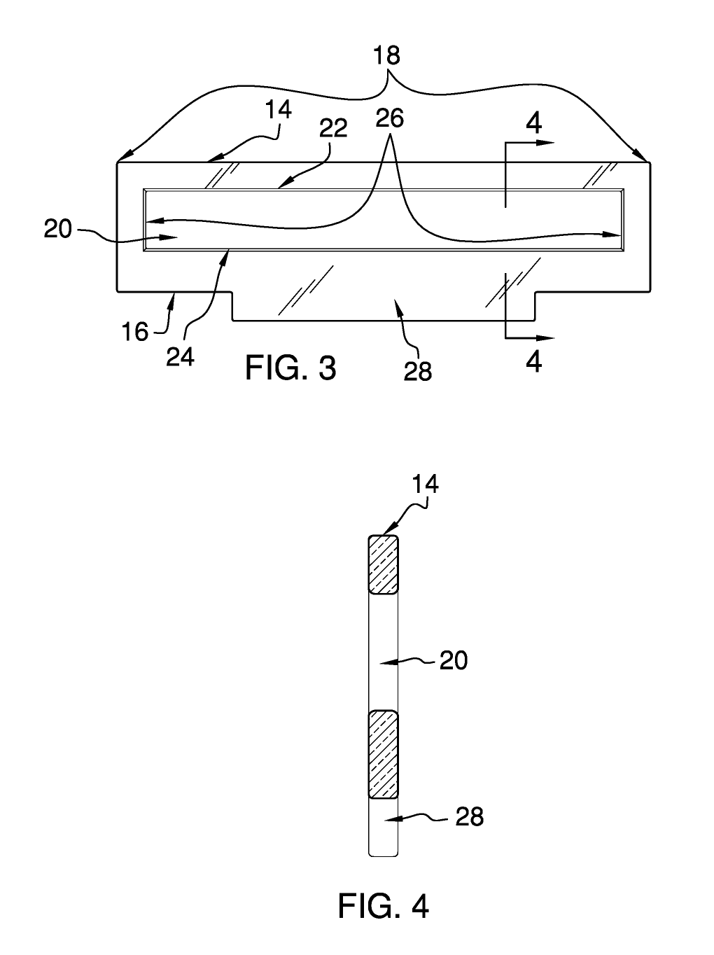

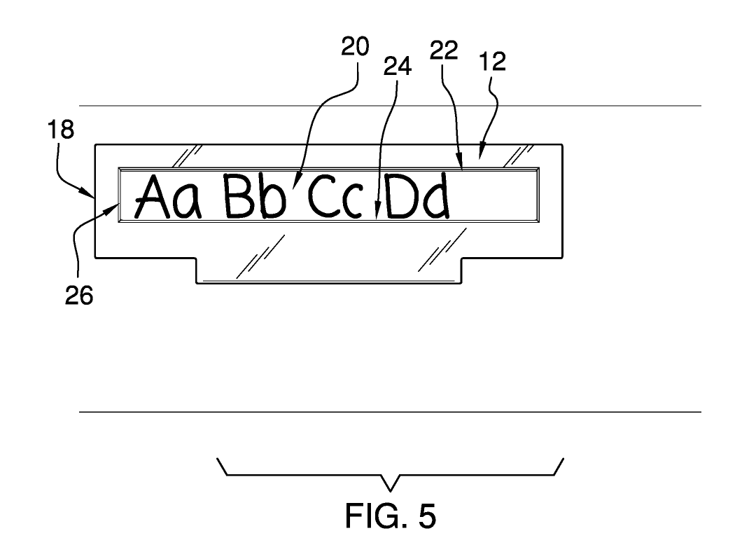

With reference now to the drawings, and in particular to FIGS. 1 through 5 thereof, a new writing guide embodying the principles and concepts of an embodiment of the disclosure and generally designated by the reference numeral 10 will be described.

As best illustrated in FIGS. 1 through 5, the writing guide 10 generally comprises a mask 12 that is substantially rectangularly shaped. The mask 12 has a top 14, a bottom 16 and opposing sides 18. In one embodiment, the opposing sides 18 are separated by from fifteen to thirty centimeters. In another embodiment, the opposing sides 18 are separated by from twenty to twenty five centimeters. In yet another embodiment, the opposing sides 18 are separated by from twenty three to twenty four centimeters.

In one embodiment, the mask 12 is from forty to eighty millimeters thick. In another embodiment, the mask 12 is from fifty to seventy millimeters thick. In yet another embodiment, the mask 12 is from sixty to sixty five millimeters thick. The mask 12 is substantially transparent. The mask 12 comprises plastic.

An aperture 20 is positioned through the mask 12. The aperture 20 is substantially rectangularly shaped. The aperture 20 has a top edge 22, a bottom edge 24 and opposing side edges 26. The aperture 20 is substantially centrally positioned in the mask 12. The aperture 20 is sized such that the opposing side edges 26 are substantially alignable with the side edges of a sheet of lined paper.

In one embodiment, the opposing side edges 26 are separated by from sixteen to twenty eight centimeters. In another embodiment, the opposing side edges 26 are separated by from twenty one to twenty four centimeters. In yet another embodiment, the opposing side edges 26 are separated by from twenty two to twenty three centimeters.

A tab 28 is coupled to the bottom 16 of the mask 12. The tab 28 is positioned on the mask 12 such that the tab 28 is configured for positioning of one or more of a user's fingers on the tab 28 to facilitate repositioning of the mask 12 relative to the sheet of lined paper. The tab 28 is substantially centrally positioned on the bottom 16. The tab 28 is substantially rectangularly shaped. The tab 28 is substantially transparent.

In use, the mask 12 is configured for positioning over a sheet of lined paper. The top edge 22 and the bottom edge 24 of the aperture 20 are alignable with respective lines of the sheet of lined paper, such that a first writing space of the sheet of lined paper is accessible to a writing instrument positioned through the aperture 20. The mask 12 covers at least one writing space above and one writing space below the first writing space, such that the user is restricted to writing in the first writing space until the mask 12 is repositioned relative to the sheet of lined paper.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A writing guide comprising:
a mask, said mask being substantially rectangularly shaped, said mask having a top, a bottom and opposing sides;
an aperture positioned through said mask, said aperture being substantially rectangularly shaped, said aperture having a top edge, a bottom edge and opposing side edges; and
wherein said mask is configured for positioning over a sheet of lined paper, such that said top edge and said bottom edge of said aperture are alignable with respective lines of the sheet of lined paper, wherein a first writing space of the sheet of lined paper is accessible to a writing instrument positioned through said aperture, wherein said mask covers at least one writing space above and one writing space below the first writing space, such that a user is restricted to writing in the first writing space until said mask is repositioned relative to the sheet of lined paper.

2. The guide of claim 1, further including said aperture being sized such that said opposing side edges are substantially alignable with the side edges of a sheet of lined paper.

3. The guide of claim 1, further including said aperture being substantially centrally positioned in said mask.

4. The guide of claim 2, further comprising:
said opposing sides being separated by from fifteen to thirty centimeters; and
said opposing side edges being separated by from sixteen to twenty eight centimeters.

5. The guide of claim 4, further comprising:
said opposing sides being separated by from twenty to twenty five centimeters; and
said opposing side edges being separated by from twenty one to twenty four centimeters.

6. The guide of claim 5, further comprising:
said opposing sides being separated by from twenty three to twenty four centimeters; and
said opposing side edges being separated by from twenty two to twenty three centimeters.

7. The guide of claim 1, further including said mask being from forty to eighty millimeters thick.

8. The guide of claim 7, further including said mask being from fifty to seventy millimeters thick.

9. The guide of claim 8, further including said mask being from sixty to sixty five millimeters thick.

10. The guide of claim 1, further including said mask being substantially transparent.

11. The guide of claim 1, further including said mask comprising plastic.

12. The guide of claim 1, further including a tab coupled to said bottom of said mask, wherein said tab is positioned on said mask such that said tab is configured for positioning of one or more of a user's fingers on said tab to facilitate repositioning of said mask relative to the sheet of lined paper.

13. The guide of claim 12, further including said tab being substantially centrally positioned on said bottom.

14. The guide of claim 12, further including said tab being substantially rectangularly shaped.

15. The guide of claim 12, further including said tab being substantially transparent.

16. A writing guide comprising:
a mask, said mask being substantially rectangularly shaped, said mask having a top, a bottom and opposing sides, said opposing sides being separated by from fifteen to thirty centimeters, said opposing sides being separated by from twenty to twenty five centimeters, said opposing sides being separated by from twenty three to twenty four centimeters, said mask being from forty to eighty millimeters thick, said mask being from fifty to seventy millimeters thick, said mask being from sixty to sixty five millimeters thick, said mask being substantially transparent, said mask comprising plastic;
an aperture positioned through said mask, said aperture being substantially rectangularly shaped, said aperture having a top edge, a bottom edge and opposing side edges, said aperture being substantially centrally positioned in said mask, said aperture being sized such that said opposing side edges are substantially alignable with the side edges of a sheet of lined paper, said opposing side edges being separated by from sixteen to twenty eight centimeters, said opposing side edges being separated by from twenty one to twenty four centimeters, said opposing side edges being separated by from twenty two to twenty three centimeters; and
a tab coupled to said bottom of said mask, wherein said tab is positioned on said mask such that said tab is configured for positioning of one or more of a user's fingers on said tab to facilitate repositioning of said mask relative to the sheet of lined paper, said tab being substantially centrally positioned on said bottom, said tab being substantially rectangularly shaped, said tab being substantially transparent;
wherein said mask is configured for positioning over a sheet of lined paper, such that said top edge and said bottom edge of said aperture are alignable with respective lines of the sheet of lined paper, wherein a first writing space of the sheet of lined paper is accessible to a writing instrument positioned through said aperture, wherein said mask covers at least one writing space above and one writing space below the first writing space, such that a user is restricted to writing in the first writing space until said mask is repositioned relative to the sheet of lined paper.
